(19) United States
(12) Patent Application Publication
(10) Pub. No.: US 2004/0041370 A1
(43) Pub. Date: Mar. 4, 2004

(54) Slide attachment for air bag canister to instrument panel

(75) Inventors: Michael Joseph Hier, Milford Township, MI (US); Joseph J. Davis JR., Ortonville, MI (US)

Correspondence Address: Pete N. Kiousis, Brooks & Kushman P.C., 22nd Floor, 1000 Town Center, Southfield, MI, 48075-1351, US

(73) Assignee: LEAR CORPORATION, Southfield, MI

(21) Appl. No.: 10/232,022

(22) Filed: Aug. 30, 2002

(51) Int. Cl. B60R 21/16

(52) U.S. Cl. 280/728.2

(57) ABSTRACT

An instrument panel comprising an instrument panel body having an under surface. The under surface has a tear seam to facilitate deployment of an air bag. The instrument panel also includes brackets comprising one of a plurality of axially spaced sections or axially spaced slots. The air bag module includes a plurality of the other of the axially spaced sections or axially spaced slots sized to be received in one of the plurality of axially spaced sections or axially spaced slots spaced sections. The air bag module is attached to the instrument panel by inserting one of the axially spaced sections or axially spaced sections into the other of the axially spaced sections or the axially spaced slots in the bracket and sliding the air bag module relative to the bracket.

### BACKGROUND OF THE INVENTION

1. Field of the Invention

This invention relates generally to an air bag support for a vehicle air bag which provides a seamless instrument panel.

2. Background Art

Incorporation of air bags into vehicles has created many design challenges for automotive designers. It is desirable to incorporate an air bag into an instrument panel in front of the vehicle passenger seat. When incorporating an air bag into an instrument panel it is necessary to provide an air bag cover that will reliably and safely tear so that the air bag can deploy and protect the passenger. Tear seams have been provided to ensure that the air bag will deploy properly.

Vehicle designers prefer to have a continuous visible surface on the front face of the instrument panel whenever possible and would therefore avoid having a visible tear seam in the instrument panel. Thus, recently there has been an effort to achieve a “seamless” design wherein there is no indication on the front face of the instrument panel that the air bag is behind the instrument panel. To achieve this design, tear seams provided in the instrument panel are only provided on the under face, and not on the front face of the instrument panel.

A major design challenge with such “seamless” designs has been to provide an appropriate air bag support assembly for supporting the air bag before, during and after deployment through the instrument panel. Typically the air bag support assembly has been tailored to specific instrument panel configurations because the air bag support assembly is an integral part of the instrument panel itself. The instrument panel often requires additional support members near the air bag support assembly and the air bag support assembly must fit between these additional support members. Another challenge is that when the configuration of an instrument panel is changed, frequently the air bag support assembly must also be redesigned to fit in the new instrument panel.

Thus, it is desirable to create an air bag support assembly for an air bag that is independent of the instrument panel and that is standardized so that it can be incorporated in the “seamless” design of a variety of instrument panel configurations. Preferably, such an air bag support assembly would be simpler in design than current air bag support assemblies and permit a reduction in the number of additional support members currently used to support instrument panels adjacent to the air bag. Such a design would be readily adaptable to changes in the styling and configuration of the instrument panel.

### SUMMARY OF THE INVENTION

The present invention discloses an instrument panel comprising an instrument panel body having a visible surface and an under surface. The instrument panel has brackets that extend rearwardly from the under surface comprising one of a plurality of axially spaced sections or axially spaced slots. The instrument panel also having a door circumscribed by at least one flexible hinge and at least one tear seam. The brackets provide support for an air bag module that includes a plurality of the other of the axially spaced sections or axially spaced slots sized to be received in one of the plurality of axially spaced sections or axially spaced slots spaced sections. The air bag module is secured to the brackets by inserting one of the axially spaced sections or axially spaced sections of the bracket into the other of the axially spaced sections or the axially spaced slots in the support structure and sliding the air bag module relative to the brackets.

The present invention also discloses an instrument panel comprising an instrument panel body having a visible surface and an under surface. The under surface has a tear seam to facilitate deployment of an air bag. The instrument panel also includes an air bag support assembly having an outer rim, a hinge member, a support structure, a door flap having a plurality of outer edges, and brackets that extend rearwardly from the outer rim comprising one of a plurality of axially spaced sections or axially spaced slots. The hinge member connects one of the plurality of outer edges to the outer rim. The support structure is secured to the outer rim and provides a support for an air bag module. The air bag module includes a plurality of the other of the axially spaced sections or axially spaced slots sized to be received in one of the plurality of axially spaced sections or axially spaced slots spaced sections. The outer rim and the door flap is secured to the under surface of the instrument panel body. The air bag module is attached to the air bag support assembly by inserting one of the axially spaced sections or axially spaced sections of the bracket rim into the other of the axially spaced sections or the axially spaced slots in the support structure and sliding the air bag module relative to the support structure.

These and other features and advantages of this invention will become more apparent to those skilled in the art from the following detailed description of the presently preferred embodiment. The drawings that accompany the detailed description can be described as follows.

### BRIEF DESCRIPTION OF THE DRAWINGS

FIG. 1 is a front view of an instrument panel having an air bag support designed according to the present invention;

FIG. 2 is a cross-sectional view along line 3-3 of FIG. 1;

FIG. 3 is a perspective view of one method of attaching the air bag module to the instrument panel;

FIGS. 4a-4f are cross-sectional views of various axially spaced sections and slots; and

FIG. 5 is a plan view of one embodiment of air bag channel according to the present invention.

FIG. 6 is a cross sectional view of another embodiment of the present invention along line 3-3 of FIG. 1.

### DETAILED DESCRIPTION OF THE PREFERRED EMBODIMENT(S)

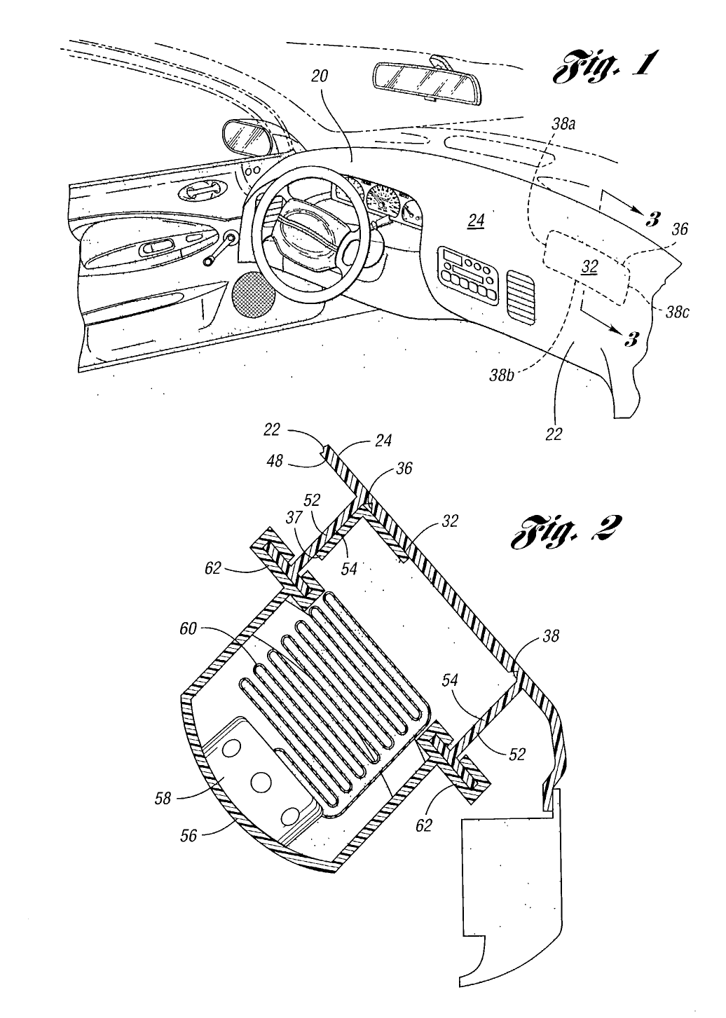

A vehicle instrument panel is shown generally at 20 in FIG. 1. The vehicle instrument panel 20 includes an instrument panel body 22 having a visible surface 24.

FIG. 2 depicts a cross-sectional view of the instrument panel 22 along line 3-3. The instrument panel 22 includes a visible surface 24 and an under surface 48. A second layer of material (not shown) can be applied over the visible surface 24 to enhance the visual appearance of the instrument panel. Preferably, the instrument panel 22 is injection molded having a support structure 52 extending back from the under surface 48. In the embodiment shown in FIG. 2, the support structure 52 has T-shaped brackets 54 disposed at the ends of the support structure.

The instrument panel 22 has a door 32 through which an air bag deploys. The door 32 is circumscribed by a flexible hinge 36 and tear seams 38a, 38b, and 38c. The tear seams 38a, 38b, and 38c rupture to allow the door to open and pivot along the flexible hinge. One skilled in the art could devise a door 32 having a different shape and therefore have differently shaped hinges and tear seams. A restraining member 37 may be secured to the door 32 and support structure 52 to assist in maintaining the door to the instrument panel 22.

An air bag module 56 having an air bag inflator 58 and an air bag 60 is located behind the instrument panel 22. The shape of the air bag module 56, air bag inflator 58 and air bag 60 may vary from that shown, as is known in the art. The air bag module 56 includes a pair of channels 62. The channels 62 are shaped to slidably cooperate with a portion of the T-shaped brackets 54.

When the air bag 60 is inflated, it will deploy against the underside of the door 32 and the flexible hinge 36. The air bag 60 ruptures the tear seams 38a, 38b, 38c of the instrument panel body 22. The flexible hinge 36 maintains the door 32 to the instrument panel body 22 and allows the door to rotate outwardly so that the air bag 60 can be deployed into the passenger compartment.

Referring now to FIG. 3, the support structure 52 is shown having a plurality of axially spaced sections 70 having a T-shaped cross-section. The length of each axially spaced section 70 can vary. The air bag module is shown as having first 72 and second 74 walls making up the channel 62 and a plurality of axially spaced slots 76 therein. According to this embodiment, first 78 and second lips 80 extend inwardly from first and second walls 72, 74 leaving a channel 82 therebetween. Between the axially spaced slots are a plurality of openings 84. To assemble the air bag module 56 to the support structure rail, the air bag module is positioned such that the axially spaced sections 70 are in the openings 84. The air bag module 56 is then slid as indicated by the arrows such that the axially spaced sections 70 are in the axially spaced slots 76 thereby retaining the air bag module to the instrument panel.

Although the axially spaced sections 70 are shown on the support structure 52 and the axially spaced slots 76 are shown on the air bag module 56, the axially spaced slots may be on the support structure and the axially spaced sections may be on the air bag module.

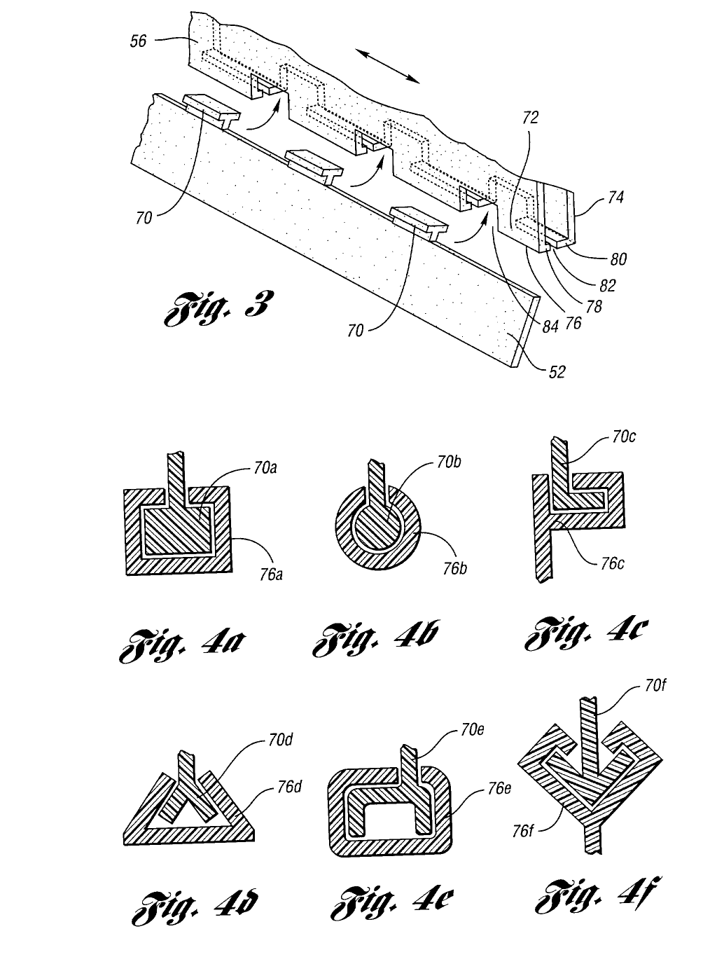

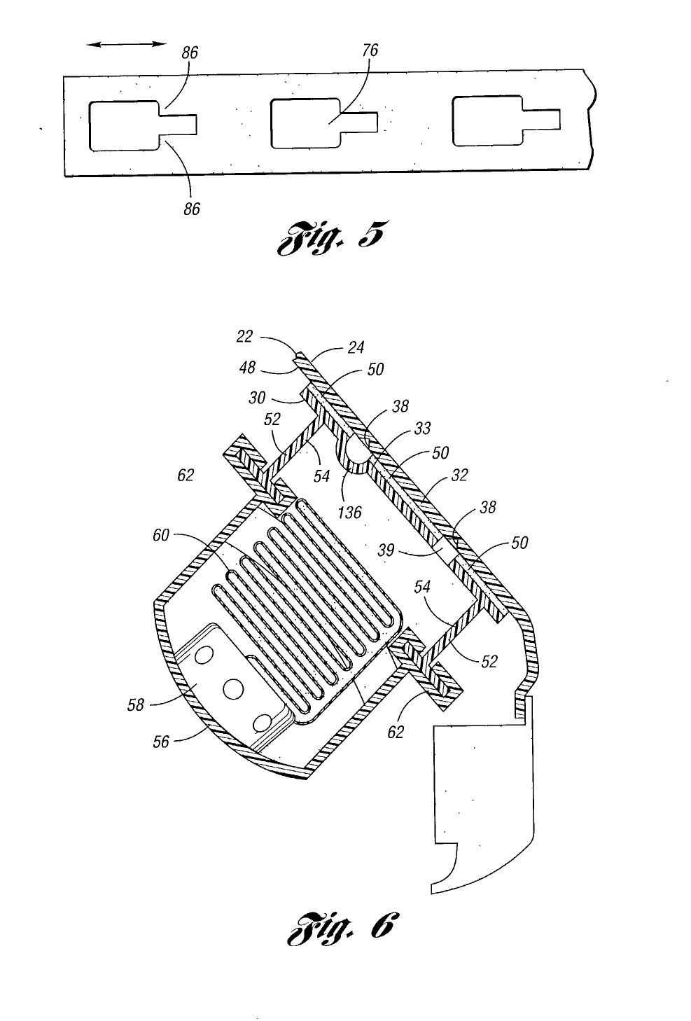

The axially spaced sections 70 and the axially spaced slots 76 can of course be shaped otherwise. FIG. 4a shows a rectangular axially spaced section 70a and a rectangular shaped slot 76a. FIG. 4b shows a circular cross-section of a axially spaced section 70b and a circular slot 76b. FIG. 4c shows a L-shaped axially shape section 70c and a rectangular spaced slot 76c. FIGS. 4d, 4e, and 4f show variations of a Y-shaped axially spaced sections 70d, 70e, 70f and assorted slots 76d, 76e, 70f.

FIG. 5 shows a plan view of a section showing another embodiment of the axially spaced slots 76. In this embodiment, the axially spaced section (not shown) would be positioned into the openings and slid as shown by the arrows so that portions of the axially spaced section would be underneath flaps 86 of the axially spaced section. Flaps 86 on the bracket would prevent the axially spaced sections from dislodging from the axially spaced slots.

Another embodiment of the present invention is shown in FIG. 6. In this embodiment, an air bag support assembly 30 is provided that includes the support structure 52 and a door flap 33. A welded joint 50 secures the air bag support assembly 30 to the under surface 48. Alternatively, adhesive could be used to secure the air bag support assembly 30 to the instrument panel 22.

The air bag support assembly 30 has a hinge member 136 and a gap 39 to create a door flap 33 which aligns with the door 32 in the instrument panel 22. The gap 39 and the hinge member 136 circumscribe the door flap such that the door flap can freely pivot about the hinge member. The door 32 in the instrument panel 22 may be completely circumscribed by tear seams 38 or, alternatively, the door may have a flexible hinge 36 that aligns with the hinge member 136. The gap 39 is positioned proximate at least some of the tear seams 38 on the instrument panel such that the door panel 32 can pivot freely with the door 32 when the tear seams 38 in the instrument panel 22 are ruptured.

When the air bag 60 deploys, it exerts force against the door flap 33 and the door 32 causing the tear seams 38 to rupture. The force of the deployment causes the door flap 33 and the door 32 to flex outwardly about the hinge member 136 thereby providing a passageway for the deploying air bag 60 into the passenger compartment. The weld joint 50 maintains the contact between the under surface 48 and the door flap 33.

Preferably, the air bag support assembly 30 is formed of material that is molecularly compatible with the instrument panel 22. For example, if the instrument panel 22 is made from a PC/ABS blend, then the air bag support structure 30 may be formed from a TPU material. One skilled in the art could readily determine other combinations of compatible materials. Also, it is most preferable that the air bag support assembly 30 including the door flap 32 be vibration welded to the under face 48 of the instrument panel body 22 to form the welded joint 50. The vibration weld provides a very strong connection between the air bag support assembly 30 and the instrument panel body 22. Forming the air bag support assembly 30 from a thermoplastic also enables the air bag support assembly 30 including the door flap 32 to conform to the shape of the under face 48 so the same standardized design can be used in instrument panels having a variety of configurations.

By having a plurality of axially spaced sections 70 and axially spaced slots 71, the air bag module can be attached to the instrument panel in a much simpler and efficient manner. For example, prior applications required that the air bag module be slid approximately 12-24 inches to fully engage the support structure of the instrument panel. By using a plurality of axially spaced sections 70 and axially spaced slots 76, the air bag module may be attached to the support structure by merely sliding the air bag module several inches. Further, the air bag module can be attached from either the right or left direction to allow for more assembly flexibility and compensate for part variances and expansion rates.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An instrument panel comprising:
an instrument panel body having a visible surface and an under surface; the instrument panel having brackets that extend rearwardly from the under surface comprising one of a plurality of axially spaced sections or axially spaced slots, the instrument panel also having a door circumscribed by at least one flexible hinge and at least one tear seam;
the brackets providing support for an air bag module, the air bag module including a plurality of the other of the axially spaced sections or axially spaced slots sized to be received in one of the plurality of axially spaced sections or axially spaced slots spaced sections; and
wherein the air bag module is secured to the brackets by inserting one of the axially spaced sections or axially spaced sections of the bracket into the other of the axially spaced sections or the axially spaced slots in the support structure and sliding the air bag module relative to the brackets.

2. The instrument panel of claim 1 wherein the axially spaced sections are T-shaped.

3. The instrument panel of claim 1 wherein the axially spaced slots have a first lip and a second lip.

4. The instrument panel of claim 1 wherein the axially spaced sections are L-shaped.

5. The instrument panel of claim 1 wherein the axially spaced section is rectangular in cross-section.

6. The instrument panel of claim 1 further comprising a retainer member secured to the door and at least one of the brackets.

7. The instrument panel of claim 1 wherein the axially spaced section is Y-shaped in cross section.

8. The instrument panel of claim 1 wherein the brackets are integrally molded to the instrument panel.

9. The instrument panel of claim 1 further comprising a support structure wherein the brackets are part of the support structure, the support structure being secured to the instrument panel.

10. An instrument panel comprising:
an instrument panel body having a visible surface and an under surface; the instrument panel having brackets that extend rearwardly from the under surface comprising a plurality of axially spaced sections, the instrument panel also having a door circumscribed by a flexible hinge and a tear seam;
the brackets providing support for an air bag module, the air bag module including a plurality of axially spaced slots sized to be received in the plurality of axially spaced sections; and
wherein the air bag module is attached to the brackets by inserting the axially spaced sections of the bracket into the axially spaced slots in the support structure and sliding the air bag module relative to the brackets.

11. The instrument panel of claim 10 wherein the axially spaced sections are T-shaped.

12. The instrument panel of claim 10 wherein the axially spaced slots have a first lip and a second lip.

13. The instrument panel of claim 10 wherein the axially spaced sections are L-shaped.

14. The instrument panel of claim 10 wherein the axially spaced section is rectangular in cross-section.

15. The instrument panel of claim 10 wherein the brackets are integrally molded to the instrument panel.

16. The instrument panel of claim 10 further comprising a support structure wherein the brackets are part of the support structure, the support structure being secured to the instrument panel.

17. An instrument panel comprising:
an instrument panel body having a visible surface and an under surface, the under surface having a tear seam to facilitate deployment of an air bag;
an air bag support assembly comprising an outer rim, a hinge member, a support structure, a door flap having a plurality of outer edges, and brackets that extend rearwardly from the outer rim comprising one of a plurality of axially spaced sections or axially spaced slots;
the hinge member connecting one of the plurality of outer edges to the outer rim;
the support structure secured to the outer rim and providing a support for an air bag module, the air bag module including a plurality of the other of the axially spaced sections or axially spaced slots sized to be received in one of the plurality of axially spaced sections or axially spaced slots spaced sections; and
the outer rim and the door flap is secured to the under surface of the instrument panel body wherein the air bag module is attached to the air bag support assembly by inserting one of the axially spaced sections or axially spaced sections of the bracket rim into the other of the axially spaced sections or the axially spaced slots in the support structure and sliding the air bag module relative to the support structure.

18. The instrument panel as recited in claim 1, wherein the outer rim and the door flap are secured to the instrument panel body by welding.

19. The instrument panel of claim 1 wherein the axially spaced sections are T-shaped.

20. The instrument panel of claim 1 wherein the axially spaced slots have a first lip and a second lip.
